(19) United States
(12) Patent Application Publication
(10) Pub. No.: US 2026/0299350 A1
(43) Pub. Date: Oct. 1, 2026

(54) LIQUID CRYSTAL LENS AND DISPLAY DEVICE

(71) Applicant: Beijing Shiyan Technology Co., Ltd., Beijing (CN)

(72) Inventors: Jingjing Jiang, Beijing (CN); Xiaolong Li, Beijing (CN); Kuanjun Peng, Beijing (CN); Tao Hong, Beijing (CN); Changfeng Li, Beijing (CN); Tieshi Wang, Beijing (CN); Jian Gao, Beijing (CN); Jing Yu, Beijing (CN)

(73) Assignee: Beijing Shiyan Technology Co., Ltd., Beijing (CN)

(21) Appl. No.: 18/996,487

(22) PCT Filed: May 14, 2024
(86) PCT No.: PCT/CN2024/093062

§ 371 Date: Jan. 17, 2025

(30) Foreign Application Priority Data
Jun. 21, 2023 (CN) 202310744255.8

(51) Int. Cl. G02F 1/1335; G02F 1/1333; G02F 1/1339; G02F 1/1343

(52) U.S. Cl. CPC G02F 1/133526; G02F 1/133368; G02F 1/133502; G02F 1/133512; G02F 1/13396; G02F 1/134309

(57) ABSTRACT

A liquid crystal lens and a display device are provided. The liquid crystal lens includes: a first substrate and a second substrate arranged opposite to each other, and a liquid crystal layer located between the first substrate and the second substrate; at least one of the first electrode layer included in the first substrate and the second electrode layer included in the second substrate comprises at least one sub-electrode layer, the sub-electrode layer comprises a plurality of electrode patterns arranged in sequence, and there is a gap between adjacent electrode patterns; the liquid crystal lens further comprises at least one light compensation layer, at least part of the light compensation layer is filled between adjacent electrode patterns in the sub-electrode layer, and the refractive index of the light compensation layer is substantially the same as the refractive index of the sub-electrode layer.

### CROSS-REFERENCE TO RELATED APPLICATIONS

The present disclosure claims priority to Chinese patent application No. 202310744255.8 filed on Jun. 21, 2023, the entire contents of which are incorporated herein by reference.

### TECHNICAL FIELD

The present disclosure relates to the field of display technology, and in particular to a liquid crystal lens and a display device.

### BACKGROUND

Naked-eye 3D display technology can reproduce stereoscopic images with spatial depth information without the viewer wearing any equipment, and represents the main development direction of the future display field. Among the many naked-eye 3D display technologies, light field display technology can truly restore the light field distribution of objects and achieve realistic and natural 3D display effects.

Light field three-dimensional scene display generally places a microlens array in front of a liquid crystal panel. The light from the liquid crystal panel is projected to different viewing angles through the microlens array, and then gathered and restored in three-dimensional space to reproduce the three-dimensional scene of the object space, allowing the human eye to observe an image with correct parallax at the corresponding viewing angle.

Microlens arrays are key components for achieving light field 3D display. Currently, the mainstream applications are solid-state lenses made using thermal reflow technology or printing technology, and liquid crystal lens technology. Liquid crystal lens technology has broader application prospects due to its controllability and ability to achieve larger apertures. However, this type of liquid crystal lens technology is prone to diffraction crosstalk, which will affect the 3D display effect when the liquid crystal lens technology is applied to 3D display.

### SUMMARY

An object of the present disclosure is to provide a liquid crystal lens and a display device.

In order to achieve the above objectives, the present disclosure provides the following technical solutions:
the present disclosure provides a liquid crystal lens, comprising: a first substrate and a second substrate arranged opposite to each other, and a liquid crystal layer located between the first substrate and the second substrate; the first substrate comprises a first base substrate, and a first electrode layer arranged on the first base substrate, the first electrode layer being located between the first base substrate and the liquid crystal layer; the second substrate comprises a second base substrate, and a second electrode layer arranged on the second base substrate, the second electrode layer being located between the second base substrate and the liquid crystal layer; at least one of the first electrode layer and the second electrode layer comprises at least one sub-electrode layer, the sub-electrode layer comprising a plurality of electrode patterns arranged in sequence, with gaps between adjacent electrode patterns; the liquid crystal lens further comprises at least one light compensation layer, at least part of the light compensation layer fills between adjacent electrode patterns in the sub-electrode layer, and the refractive index of the light compensation layer is substantially the same as the refractive index of the sub-electrode layer.

Optionally, a thickness b of the first substrate satisfies: 0.1 mm≤b≤0.7 mm.

Optionally, the first substrate further includes a plurality of first spacers, and the second substrate further includes a plurality of second spacers, and the orthographic projections of the first spacers on the first substrate at least partially overlap with the orthographic projections of the corresponding second spacers on the first substrate;

The orthographic projection of the first spacing on the base substrate and/or the orthographic projection of the second spacing on the base substrate has a first side and a second side, and the length L2 of the second side satisfies: L2=L1+2*a; L1 is the length of the first side, and a is the process deviation for manufacturing the spacing.

Optionally, the first substrate further includes a plurality of first spacers, and the second substrate further includes a plurality of second spacers, and the orthographic projections of the first spacers on the first substrate at least partially overlap with the orthographic projections of the corresponding second spacers on the first substrate;

An extending direction of an orthographic projection of the first spacing on the first base substrate intersects with an extending direction of an orthographic projection of the second spacing on the first base substrate.

Optionally, the plurality of first spacers are divided into a plurality of first spacing groups, wherein the first spacing group includes a first central spacing and a plurality of first peripheral spacers located around the first central spacing;

The plurality of second spacers are divided into a plurality of second spacing groups, wherein the second spacing groups include a second central spacing and a plurality of second peripheral spacers located around the second central spacing;
corresponding first spacing group and second spacing group: the middle part of the orthographic projection of at least one of the first central spacing and the plurality of first peripheral spacers on the first base substrate at least partially overlaps with the middle part of the orthographic projection of the second central spacing and at least one of the plurality of second peripheral spacers on the first base substrate.

Optionally, the orthographic projection of the first central spacing on the base substrate and the orthographic projection of the second central spacing on the base substrate form a central overlapping area; the orthographic projection of the first peripheral spacing on the base substrate and the orthographic projection of the corresponding second peripheral spacing on the base substrate form a peripheral overlapping area;

The middle part or end of the first central spacing is located in the central overlapping area; the middle part or end of the second central spacing is located in the central overlapping area; the middle part or end of the first peripheral spacing is located in the peripheral overlapping area; the middle part or end of the second peripheral spacing is located in the peripheral overlapping area.

Optionally, the first spacing group includes one first central spacing and four first peripheral spacers, the first central spacing is located between the first first peripheral spacing and the second first peripheral spacing, and the first first peripheral spacing and the second first peripheral spacing are opposite to each other along a first direction; the first central spacing is located between the third first peripheral spacing and the fourth first peripheral spacing, and the third first peripheral spacing and the fourth first peripheral spacing are opposite to each other along a second direction, and the second direction intersects with the first direction;

Along the second direction, the first first peripheral spacing, the first center spacing and the second first peripheral spacing are staggered by a distance d in sequence; along the first direction, the third first peripheral spacing, the first center spacing and the fourth first peripheral spacing are staggered by a distance d in sequence.

Optionally, an orthographic projection of at least one of the first central spacing, the third first peripheral spacing and the fourth first peripheral spacing on the first substrate is mirror-symmetrical to an orthographic projection of the corresponding second spacing on the first substrate;

An orthographic projection of a first first peripheral spacing on the first substrate is mirror-symmetrical to an orthographic projection of a second first peripheral spacing corresponding to the first peripheral spacing on the first substrate;
the second first peripheral spacing on the first base substrate is mirror-symmetrical to the orthographic projection of the second spacing corresponding to the first first peripheral spacing on the first base substrate.

Optionally, the first substrate includes a first shading layer, at least part of which is located between the first spacing and the first base substrate; and/or the second substrate includes a second shading layer, at least part of which is located between the second spacing and the second base substrate.

Optionally, the first substrate includes:
alignment layer are sequentially stacked on the first substrate in a direction away from the first substrate;

The first spacing is located on a side of the first alignment layer facing away from the first base substrate;

The first light shielding layer and the gate metal layer are provided in the same layer and made of the same material; or,

The first light shielding layer is located on the surface of the gate metal layer facing away from the first substrate; or,

The first light shielding layer is located on the surface of the first insulating layer facing away from the first substrate; or,

The first light shielding layer is located on the surface of the first electrode layer facing away from the first substrate; or,

The first light shielding layer is located on a surface of the shielding layer facing away from the first substrate.

Optionally, the second substrate includes:
alignment layer are sequentially stacked on the second base substrate in a direction away from the second base substrate; and the second light shielding layer is located between the second base substrate and the second planar layer.

Optionally, the first spacing and/or the second spacing includes a light-shielding spacing.

Optionally, one of the first electrode layer and the second electrode layer serves as a pixel electrode, and the other serves as a common electrode, and a shielding layer is provided between the pixel electrode and the liquid crystal layer.

Optionally, in the case where at least one of the first electrode layer and the second electrode layer includes at least two sub-electrode layers, there is an insulating layer between adjacent sub-electrode layers, and among the adjacent sub-electrode layers, the orthographic projection of the electrode pattern in one sub-electrode layer on the first substrate at least partially overlaps with the orthographic projection of the gap between adjacent electrode patterns in another sub-electrode layer on the first substrate.

Optionally, the liquid crystal lens includes a plurality of lens control areas, and each lens control area controls a corresponding lens;

The liquid crystal lens further includes a plurality of first shorting bars and a plurality of second shorting bars, wherein the plurality of first shorting bars are located on a first side of the electrode pattern, and the plurality of second shorting bars are located on a second side of the electrode pattern, and the first side and the second side are opposite to each other along an extension direction of the electrode pattern;
is coupled to the first end of the corresponding electrode pattern in each lens control area respectively, and the second shorting rod is coupled to the second end of the corresponding electrode pattern in each lens control area respectively.

Optionally, the multiple lens control areas are divided into multiple control area units, each control area unit includes at least one lens control area;

The first shorting rod comprises a plurality of first sub-shorting rods which are independent of each other, and the first sub-shorting rods are respectively coupled to the first ends of the corresponding electrode patterns in each lens control area in the corresponding control area unit;

The second shorting rod includes a plurality of second sub-shorting rods that are independent of each other, and the second sub-shorting rods are respectively coupled to the second ends of the corresponding electrode patterns in each lens control area in the corresponding control area unit.

Optionally, the liquid crystal lens further includes a shading unit, and an orthographic projection of the shading unit on the first substrate at least partially overlaps with an orthographic projection of a boundary between adjacent control area units on the first substrate.

Optionally, the first substrate further includes a plurality of first blocking patterns and a plurality of second blocking patterns; the orthographic projections of the plurality of first blocking patterns on the first base substrate surround the orthographic projection of the liquid crystal layer on the first base substrate; the orthographic projections of the plurality of second blocking patterns on the first base substrate surround the orthographic projection of the liquid crystal layer on the first base substrate;

The second barrier pattern is located at a side of the first barrier pattern facing away from the liquid crystal layer, and a gap between adjacent first barrier patterns is located between the liquid crystal layer and the second barrier pattern.

Optionally, the second substrate further includes a plurality of third blocking patterns and a plurality of fourth blocking patterns; the orthographic projections of the third blocking patterns on the first substrate are arranged alternately with the orthographic projections of the first blocking patterns on the first substrate, and the orthographic projections of the fourth blocking patterns on the first substrate are arranged alternately with the orthographic projections of the third blocking patterns on the first substrate.

Optionally, the light compensation layer is located on a side of the sub-electrode layer facing the liquid crystal layer, the thickness of the light compensation layer in a direction perpendicular to the first substrate is greater than the thickness of the sub-electrode layer, and the light compensation layer is multiplexed as a shielding layer.

Based on the technical solution of the liquid crystal lens, a second aspect of the present disclosure provides a display device, comprising the liquid crystal lens.

### BRIEF DESCRIPTION OF THE DRAWINGS

The drawings described herein are used to provide a further understanding of the present disclosure and constitute a part of the present disclosure. The illustrative embodiments of the present disclosure and their descriptions are used to explain the present disclosure and do not constitute an improper limitation on the present disclosure. In the drawings:

FIG. 1 is a first cross-sectional schematic diagram of a liquid crystal lens provided by an embodiment of the present disclosure;

FIG. 2 is a schematic top view of a first substrate provided in an embodiment of the present disclosure;

FIG. 3 is a schematic top view of a second substrate provided in an embodiment of the present disclosure;

FIG. 4 is a first top view schematic diagram of a first spacing and a second spacing provided in an embodiment of the present disclosure;

FIG. 5 is a second top view schematically showing a first spacing and a second spacing provided in an embodiment of the present disclosure;

FIG. 6 is a third top view of a first spacing and a second spacing provided in an embodiment of the present disclosure;

FIG. 7 is a fourth top view of a first spacing and a second spacing provided in an embodiment of the present disclosure;

FIG. 8 is a fifth top view of a first spacing and a second spacing provided in an embodiment of the present disclosure;

FIG. 9 is a schematic top view of a first spacing provided in an embodiment of the present disclosure;

FIG. 10 is a sixth top view of a first spacing and a second spacing provided in an embodiment of the present disclosure;

FIG. 11 is a seventh top view of a first spacing and a second spacing provided in an embodiment of the present disclosure;

FIG. 12 is an eighth top view of a first spacing and a second spacing provided in an embodiment of the present disclosure;

FIG. 13 is a ninth top view of the first spacing and the second spacing provided in the embodiment of the present disclosure;

FIG. 14 is a tenth schematic top view of a first spacing and a second spacing provided in an embodiment of the present disclosure;

FIG. 15 is a second cross-sectional schematic diagram of a liquid crystal lens provided in an embodiment of the present disclosure;

FIG. 16 is a third cross-sectional schematic diagram of a liquid crystal lens provided in an embodiment of the present disclosure;

FIG. 17 is a fourth cross-sectional schematic diagram of a liquid crystal lens provided in an embodiment of the present disclosure;

FIG. 18 is a fifth cross-sectional schematic diagram of a liquid crystal lens provided in an embodiment of the present disclosure;

FIG. 19 is a sixth cross-sectional schematic diagram of a liquid crystal lens provided in an embodiment of the present disclosure;

FIG. 20 is a seventh cross-sectional schematic diagram of a liquid crystal lens provided in an embodiment of the present disclosure;

FIG. 21 is an eighth cross-sectional schematic diagram of a liquid crystal lens provided in an embodiment of the present disclosure;

FIG. 22 is a ninth cross-sectional schematic diagram of a liquid crystal lens provided in an embodiment of the present disclosure;

FIG. 23 is a tenth cross-sectional schematic diagram of a liquid crystal lens provided in an embodiment of the present disclosure;

FIG. 24 is a schematic diagram of an eleventh cross-section of a liquid crystal lens provided in an embodiment of the present disclosure;

FIG. 25 is a twelfth cross-sectional schematic diagram of a liquid crystal lens provided in an embodiment of the present disclosure;

FIG. 26 is a schematic diagram of coupling a first shorting bar and a second shorting bar to an electrode pattern provided by an embodiment of the present disclosure;

FIG. 27 is a schematic diagram of the division of control area units provided in an embodiment of the present disclosure;

FIG. 28 is a schematic diagram of a control area unit covered with a shading unit according to an embodiment of the present disclosure;

FIG. 29 is a schematic diagram of a combination of a liquid crystal lens and a display panel provided by an embodiment of the present disclosure;

FIG. 30 is a schematic diagram of the layout of a first blocking pattern and a second blocking pattern on a first substrate provided by an embodiment of the present disclosure;

FIG. 31 is a schematic diagram of the layout of the first barrier pattern, the second barrier pattern, the third barrier pattern, and the fourth barrier pattern provided in an embodiment of the present disclosure; and

FIG. 32 is a thirteenth cross-sectional schematic diagram of the liquid crystal lens provided in an embodiment of the present disclosure.

### DETAILED DESCRIPTION

In order to further illustrate the liquid crystal lens and the display device provided by the embodiments of the present disclosure, a detailed description is given below in conjunction with the accompanying drawings.

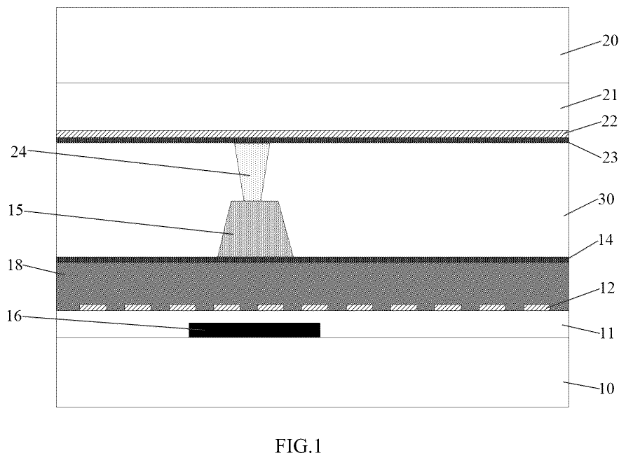

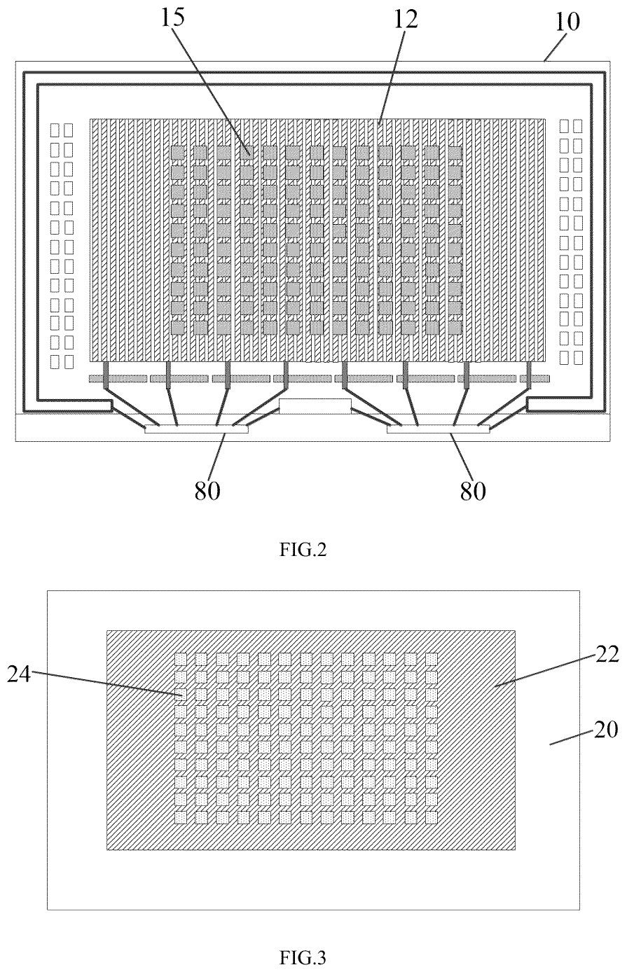

Referring to FIGS. 1 to 3, 29 and 32, an embodiment of the present disclosure provides a liquid crystal lens, comprising: a first substrate and a second substrate arranged opposite to each other, and a liquid crystal layer 30 located between the first substrate and the second substrate; the first substrate comprises a first base substrate 10, and a first electrode layer 12 arranged on the first base substrate 10, and the first electrode layer 12 is located between the first base substrate 10 and the liquid crystal layer 30;

The second substrate includes a second base substrate 20 and a second electrode layer 22 disposed on the second base substrate 20, wherein the second electrode layer 22 is located between the second base substrate 20 and the liquid crystal layer 30;

At least one of the first electrode layer 12 and the second electrode layer 22 includes at least one sub-electrode layer, and the sub-electrode layer includes a plurality of electrode patterns A arranged in sequence, and there is a gap between adjacent electrode patterns A;

The liquid crystal lens further includes at least one light compensation layer 18, at least part of which is filled between adjacent electrode patterns A in the sub-electrode layer, and the refractive index of the light compensation layer 18 is substantially the same as that of the sub-electrode layer.

Exemplarily, the light compensation layer 18 may be filled only between adjacent electrode patterns A in the sub-electrode layer, or the light compensation layer 18 may not only be filled between adjacent electrode patterns A in the sub-electrode layer but also cover the sub-electrode layer.

Exemplarily, the thickness of the light compensation layer 18 is greater than or equal to the thickness of the electrode pattern A.

Exemplarily, the difference between the refractive index of the light compensation layer 18 and the refractive index of the sub-electrode layer is between −0.2 and +0.2, including endpoint values.

Exemplarily, the light compensation layer 18 includes a cured liquid crystal layer. The specific process flow includes: after making the sub-electrode layer, coating and aligning the polyimide liquid, then coating the liquid crystal, and then curing it by ultraviolet light and heat curing to form the cured liquid crystal layer, and then making the subsequent film layer.

Exemplarily, at least a portion of the light compensation layer 18 is located on a side of the sub-electrode layer facing the liquid crystal layer 30.

According to the specific structure of the liquid crystal lens provided by the embodiment of the present disclosure, in the liquid crystal lens provided by the embodiment of the present disclosure, the light compensation layer 18 is arranged to fill between the adjacent electrode patterns A in the sub-electrode layer. Since the refractive index of the light compensation layer 18 is substantially the same as the refractive index of the sub-electrode layer, the diffraction crosstalk generated between the electrode patterns A in the sub-electrode layer is well avoided, and the 3D display effect is further optimized.

Please refer to FIGS. 1 to 3 and FIG. 29. In some embodiments, one of the first electrode layer 12 and the second electrode layer 22 serves as a pixel electrode, and the other serves as a common electrode. A shielding layer 13 is disposed between the pixel electrode and the liquid crystal layer 30.

Exemplarily, by providing corresponding electric signals to the first electrode layer 12 and the second electrode layer 22, a vertical control electric field is formed between the first electrode layer 12 and the second electrode layer 22, and by setting different voltage differences, the liquid crystal molecules in the liquid crystal layer 30 are controlled to deflect under the control electric field, thereby achieving the controllability of the liquid crystal lens.

Exemplarily, when the liquid crystal lens is used in combination with a display panel, the display panel may be a liquid crystal display panel, but is not limited thereto.

Exemplarily, when the liquid crystal lens is used in combination with a display panel, the first base substrate 10 may be directed toward the display panel, that is, the first base substrate 10 may be attached to the display panel.

Exemplarily, the shielding layer 13 has an insulating function and may further have a flattening function.

Exemplarily, the thickness of the shielding layer 13 ranges from 0 to 5 μm, and may be equal to 5 μm.

It should be noted that the pixel electrode includes at least one sub-electrode layer, and the sub-electrode layer includes a plurality of electrode patterns arranged in sequence, with gaps between adjacent electrode patterns. A shielding layer 13 is disposed between the at least one sub-electrode layer and the liquid crystal layer 30.

It is worth noting that among the multiple electrode patterns, there is a slight voltage difference between the voltages of the driving signals received by adjacent electrode patterns, which will inevitably generate a lateral electric field mainly existing on the surface of the electrode pattern, disrupting the morphology of liquid crystal molecules.

In the liquid crystal lens provided in the above embodiment, a shielding layer 13 is provided between the pixel electrode and the liquid crystal layer 30, so that the shielding layer 13 can shield the influence of the lateral electric field generated by the pixel electrode on the liquid crystal layer, so that the liquid crystal layer 30 is always in a region where the vertical electric field is stable, thereby improving the controllability and stability of the liquid crystal molecules.

In some embodiments, the first substrate includes a first base substrate 10, and a first electrode layer 12 and a plurality of first spacers 15 disposed on the first base substrate 10, wherein the first electrode layer 12 is located between the first base substrate 10 and the first spacers 15; the second substrate includes a second base substrate 20, and a second electrode layer 22 and a plurality of second spacers 24 disposed on the second base substrate 20, wherein the second electrode layer 22 is located between the second base substrate 20 and the second spacers 24; the orthographic projection of the second spacing 24 on the first base substrate 10 at least partially overlaps with the orthographic projection of the corresponding first spacing 15 on the base substrate; the thickness of the first base substrate 10 is less than or equal to the thickness of the second base substrate 20.

In the liquid crystal lens provided in the above embodiment, by setting the thickness of the first base substrate 10 to be less than or equal to the thickness of the second base substrate 20, when the liquid crystal lens is combined with a display panel to form a display product, the first base substrate 10 can be set to face the display panel, so that the distance between the liquid crystal layer 30 and the display panel can be shortened, that is, the height of the liquid crystal lens on the display panel is reduced, so that the display product can achieve a larger main lobe viewing angle θ when using liquid crystal lens technology.

As shown in FIG. 1, in some embodiments, the thickness b of the first base substrate 10 is set to satisfy: 0.1 mm≤b≤0.7 mm.

Exemplarily, the first base substrate 10 and the second base substrate 20 may be glass base substrates, but are not limited thereto.

Exemplarily, the thickness b of the first base substrate 10 may be 0.1 mm, 0.2 mm, 0.3 mm, 0.4 mm, 0.5 mm, 0.6 mm, 0.7 mm, but is not limited thereto.

Exemplarily, referring to FIG. 29, θ=2*arcsin (n*sin(arctan(D/2/h)), θ is the main lobe viewing angle, n is the refractive index of the formed Lens, D is the aperture of the Lens, and h is the placement height. It should be noted that FIG. 29 also illustrates an array substrate Array and a color filter substrate CF, the array substrate Array includes a driving circuit board and a first polarizer, and the color filter substrate CF includes a color filter plate and a color filter polarizer.

The above-mentioned setting method makes it possible for the side where the first substrate 10 is located to contact the display panel when the liquid crystal lens is combined with the display panel. This can shorten the distance between the liquid crystal layer 30 and the display panel and reduce the height of the liquid crystal lens on the display panel. It can be seen from the above formula that this will be conducive to achieving a larger main lobe viewing angle.

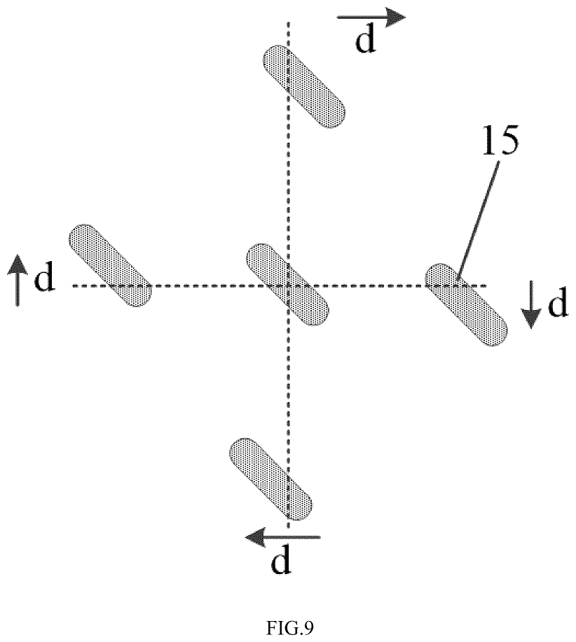

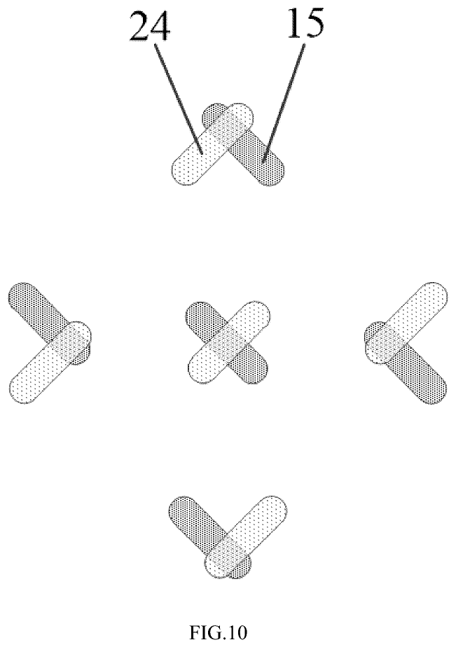

As shown in FIG. 10, in some embodiments, the first substrate further includes a plurality of first spacers 15, and the second substrate further includes a plurality of second spacers 24, and the orthographic projections of the first spacers 15 on the first base substrate 10 at least partially overlap with the orthographic projections of the corresponding second spacers 24 on the first base substrate 10;

The orthographic projection of the first spacing 15 on the base substrate and/or the orthographic projection of the second spacing 24 on the base substrate has a first side and a second side, and the length L2 of the second side satisfies: L2=L1+2*a; L1 is the length of the first side, and a is the process deviation for manufacturing the spacing.

Exemplarily, the plurality of first spacers 15 are distributed in an array, and the plurality of second spacers 24 are distributed in an array. The orthographic projection of the first spacing 15 on the first base substrate 10 at least partially overlaps with the orthographic projection of the corresponding second spacing 24 on the first base substrate 10, thereby supporting the liquid crystal box formed between the first substrate and the second substrate, and the liquid crystal box is used to accommodate the liquid crystal layer 30.

It should be noted that in order to prevent the spacers from scratching the alignment layer and causing light leakage, spacers can be set on the first substrate and the second substrate respectively for products with high box thickness. After the boxes are assembled, the spacers on different substrates are in contact and play a supporting role together.

Exemplarily, the orthographic projection of the first spacing 15 on the first base substrate 10 is located inside the orthographic projection of the corresponding second spacing 24 on the first base substrate 10.

The above-mentioned setting of the orthographic projection of the first spacing 15 on the base substrate and/or the orthographic projection of the second spacing 24 on the base substrate has the first side L1 and the second side L2, and the first side L1 and the second side L2 satisfy L2=L1+2*a, so that the size settings of the first spacing 15 and the second spacing 24 both take into account the manufacturing process deviation, ensuring that under normal process deviation, the first spacing 15 and the second spacing 24 can effectively support the box thickness.

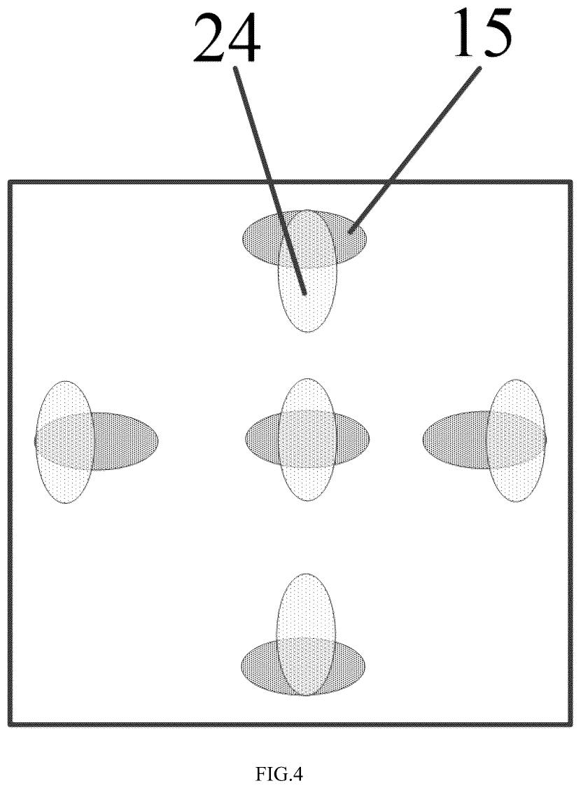

As shown in FIGS. 4 to 14, in some embodiments, the first substrate further includes a plurality of first spacers 15, and the second substrate further includes a plurality of second spacers 24, and the orthographic projections of the first spacers 15 on the first base substrate 10 at least partially overlap with the orthographic projections of the corresponding second spacers 24 on the first base substrate 10;

An extending direction of an orthographic projection of the first spacing 15 on the first base substrate 10 intersects with an extending direction of an orthographic projection of the second spacing 24 on the first base substrate 10.

Exemplarily, the orthographic projection of the first spacing 15 on the first base substrate 10 and/or the orthographic projection of the first spacing 15 on the first base substrate 10 includes the following shapes: a rounded rectangle, an ellipse, a right-angled rectangle, but is not limited thereto.

Exemplarily, an extending direction of an orthographic projection of the first spacing 15 on the first base substrate 10 is perpendicular to an extending direction of an orthographic projection of the second spacing 24 on the first base substrate 10.

The above arrangement enables the orthographic projection of the first spacing 15 on the first base substrate 10 and the orthographic projection of the second spacing 24 on the first base substrate 10 to have a larger area, and can ensure the support yield of the spacers when misalignment occurs in different directions during the box alignment process.

As shown in FIGS. 4 to 14, in some embodiments, the plurality of first spacers 15 are divided into a plurality of first spacing groups, wherein the first spacing group includes a first central spacing and a plurality of first peripheral spacers located around the first central spacing; the plurality of second spacers 24 are divided into a plurality of second spacing groups, wherein the second spacing group includes a second central spacing and a plurality of second peripheral spacers located around the second central spacing;

In the corresponding first spacing group and second spacing group: the middle part of the orthographic projection of at least one of the first central spacing and the plurality of first peripheral spacers on the first base substrate 10 at least partially overlaps with the middle part of the orthographic projection of the second central spacing and at least one of the plurality of second peripheral spacers on the first base substrate 10.

Exemplarily, a middle portion of an orthographic projection of the first central spacing on the first base substrate 10 at least partially overlaps with a middle portion of an orthographic projection of the second central spacing on the first base substrate 10.

Exemplarily, a middle portion of an orthographic projection of at least one of the plurality of first peripheral spacers on the first base substrate 10 at least partially overlaps with a middle portion of an orthographic projection of at least one of the corresponding plurality of second peripheral spacers on the first base substrate 10.

The above arrangement enables the liquid crystal lens to include at least partially corresponding first spacers 15 and second spacers 24, so that the middle parts of the spacers can be connected to each other, thus playing a good supporting role.

As shown in FIGS. 4 to 14, in some embodiments, the orthographic projection of the first central spacing on the base substrate and the orthographic projection of the second central spacing on the base substrate form a central overlapping area; the orthographic projection of the first peripheral spacing on the base substrate and the orthographic projection of the corresponding second peripheral spacing on the base substrate form a peripheral overlapping area;

The middle part or end of the first central spacing is located in the central overlapping area; the middle part or end of the second central spacing is located in the central overlapping area; the middle part or end of the first peripheral spacing is located in the peripheral overlapping area; the middle part or end of the second peripheral spacing is located in the peripheral overlapping area.

Exemplarily, the first spacing group includes a first central spacing and four first peripheral spacers located around the first central spacing, and the four first peripheral spacers can be located in the upper, lower, left, and right directions of the first central spacing. The second spacing group includes a second central spacing and four second peripheral spacers located around the second central spacing, and the four second peripheral spacers can be located in the upper, lower, left, and right directions of the second central spacing.

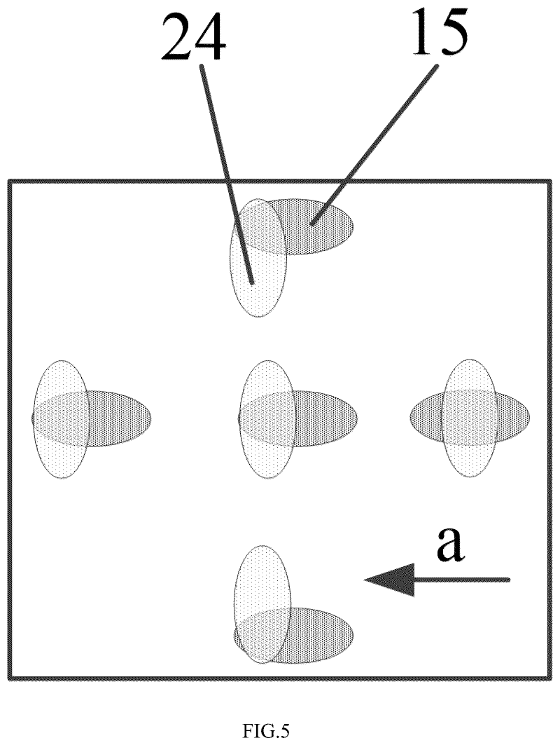

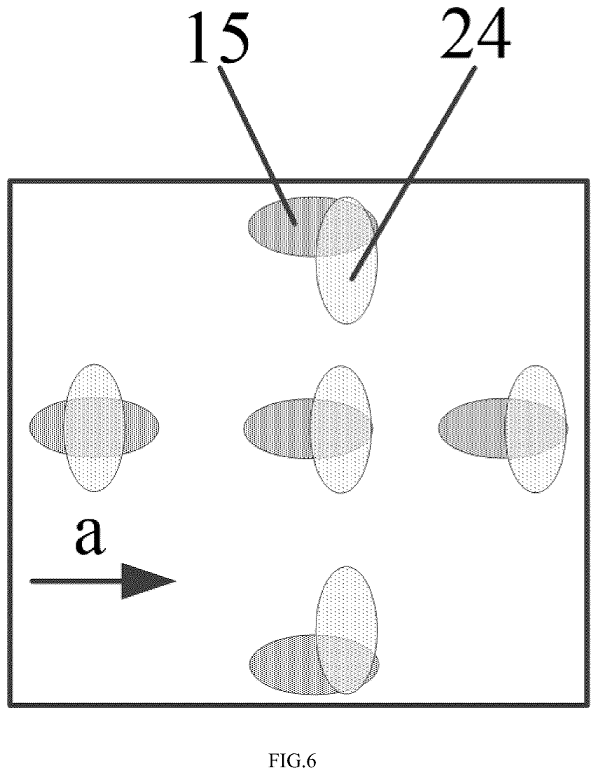

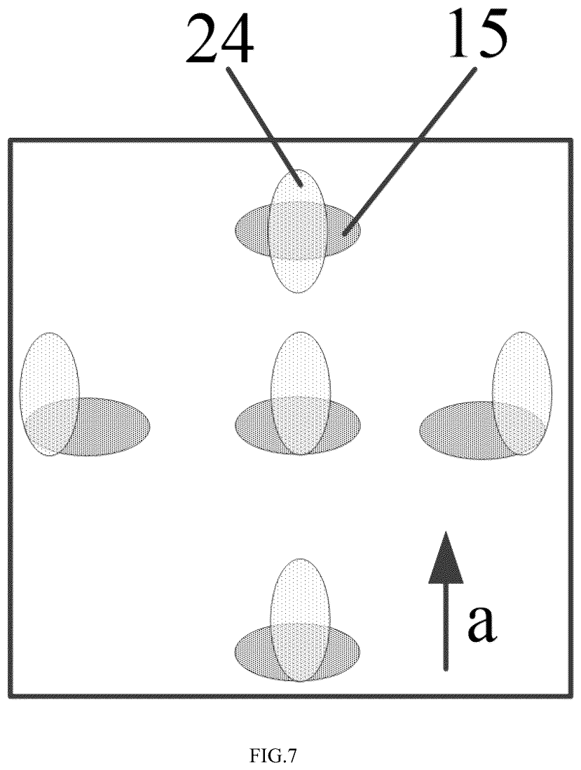

As shown in FIG. 4, in the absence of a deviation in the box alignment, the middle portion of the first central spacing is located in the central overlap region, the middle portion of the second central spacing is located in the central overlap region, the first central spacing and the second central spacing play a primary supporting role, and the four first peripheral spacers are at least partially staggered with the corresponding second peripheral spacers, playing a secondary supporting role. As shown in FIG. 5, in the case of a misalignment of the box to the left (e.g., misalignment a), the middle portion of the first peripheral spacing on the right is located in the peripheral overlap region, the middle portion of the second peripheral spacing on the right is located in the peripheral overlap region, the first peripheral spacing on the right and the corresponding second peripheral spacing on the right play a primary supporting role, and the other spacers all play a secondary supporting role. As shown in FIG. 6, in the case of a misalignment of the box to the right, the middle portion of the first peripheral spacing on the left is located in the peripheral overlap region, the middle portion of the second peripheral spacing on the left is located in the peripheral overlap region, the first peripheral spacing on the left and the corresponding second peripheral spacing on the left play a primary supporting role, and the other spacers all play a secondary supporting role. As shown in FIG. 7, when the pair of boxes is misaligned upward, the middle part of the first peripheral spacing on the upper side is located in the peripheral overlapping area, the middle part of the second peripheral spacing on the upper side is located in the peripheral overlapping area, the first peripheral spacing on the upper side and the corresponding second peripheral spacing on the upper side play a primary supporting role, and the other spacers all play a secondary supporting role. As shown in FIG. 8, when the pair of boxes is misaligned downward, the middle part of the first peripheral spacing on the lower side is located in the peripheral overlapping area, the middle part of the second peripheral spacing on the lower side is located in the peripheral overlapping area, the first peripheral spacing on the lower side and the corresponding second peripheral spacing on the lower side play a primary supporting role, and the other spacers all play a secondary supporting role.

It should be noted that there are no liquid crystal molecules at the positions of the first spacing 15 and the second spacing 24. The morphology of the first spacing 15 and the second spacing 24 will cause abnormal orientation of the alignment film during the rubbing process, which is reflected in the product performance, that is, there is light leakage near the spacing, forming crosstalk, affecting the 3D display effect. Therefore, the size of the spacing needs to be as small as possible while ensuring the process margin.

In the above embodiment, by setting the extension direction of the orthographic projection of the first spacing 15 on the first base substrate 10 to intersect with the extension direction of the orthographic projection of the second spacing 24 on the first base substrate 10, and setting each group of spacers to include a central spacing and a peripheral spacing, it is possible to ensure that, under the premise of ensuring that the size of the spacers is small enough, when the box is misaligned, it can be ensured that at least part of the middle part of the first spacing 15 can contact the middle part of the corresponding second spacing 24, thereby achieving a good supporting effect.

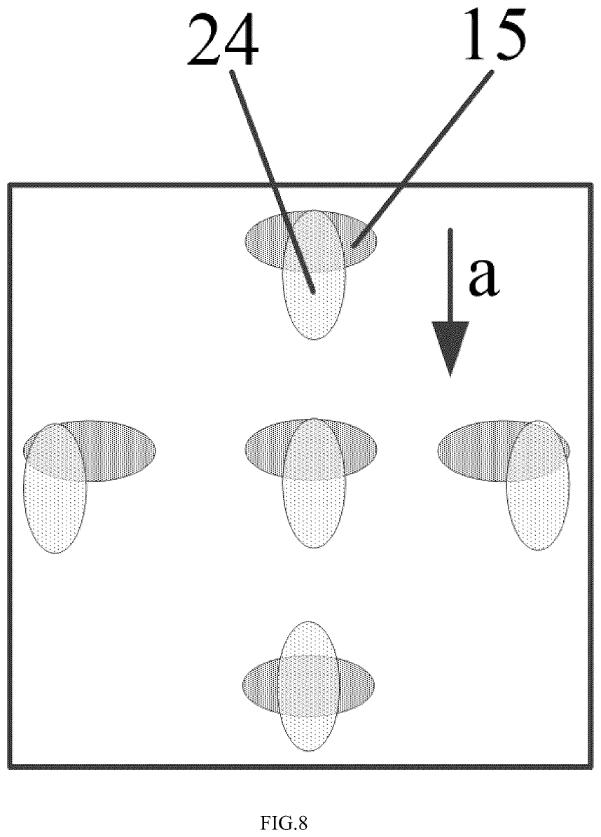

As shown in FIGS. 9 to 14, in some embodiments, the first spacing group includes one first central spacing and four first peripheral spacers, the first central spacing is located between the first first peripheral spacing (located on the left) and the second first peripheral spacing (located on the right), and the first first peripheral spacing and the second first peripheral spacing are opposite to each other along a first direction; the first central spacing is located between the third first peripheral spacing (located on the upper side) and the fourth first peripheral spacing (located on the lower side), and the third first peripheral spacing and the fourth first peripheral spacing are opposite to each other along a second direction, and the second direction intersects with the first direction;

Along the second direction, the first first peripheral spacing, the first center spacing and the second first peripheral spacing are staggered by a distance d in sequence; along the first direction, the third first peripheral spacing, the first center spacing and the fourth first peripheral spacing are staggered by a distance d in sequence.

Exemplarily, the extension directions of the first spacing 15 and the second spacing 24 both intersect with the first direction. The extension directions of the first spacing 15 and the second spacing 24 both intersect with the second direction.

Exemplarily, the first direction is perpendicular to the second direction, but is not limited thereto. For example, the first direction includes the horizontal direction, and the second direction includes the vertical direction.

For example, the distance d depends on the precision of the manufacturing process equipment. The higher the precision, the smaller the d value is, and the lower the precision, the larger the d value is. For example, the range of the d value is between 2 micrometers and 8 micrometers, including the end point value.

As shown in FIGS. 9 to 14, in some embodiments, the orthographic projection of at least one of the first central spacing, the third first peripheral spacing, and the fourth first peripheral spacing on the first base substrate 10 is mirror-symmetrical to the orthographic projection of the corresponding second spacing 24 on the first base substrate 10;

The first first peripheral spacing on the first base substrate 10 is mirror-symmetrical to the orthographic projection of the second spacing 24 corresponding to the second first peripheral spacing on the first base substrate 10;
the second first peripheral spacing on the first base substrate 10 is mirror-symmetrical to the orthographic projection of the second spacing 24 corresponding to the first first peripheral spacing on the first base substrate 10.

Exemplarily, the first spacing 15 and the second spacing 24 are symmetrical with respect to the center of the box.

The above configuration allows one mask plate to be used for manufacturing the first spacing 15 and the second spacing 24.

As shown in FIG. 9, taking the first central spacing as a reference, the third first peripheral spacing is offset to the right by a distance d along the first direction, the fourth first peripheral spacing is offset to the left by a distance d along the first direction, the first first peripheral spacing is offset upward by a distance d along the second direction, and the second first peripheral spacing is offset downward by a distance d along the second direction.

After the first substrate and the second substrate are assembled, as shown in FIG. 10, if there is no misalignment, the first center spacing and the second center spacing play a major supporting role. The other corresponding first spacers 15 and second spacers 24 are staggered by a distance of 2d in the upward, downward, left and right directions, respectively.

As shown in FIG. 11, if there is an upward misalignment, for example, a misalignment of 10 microns, the first first peripheral spacing and its corresponding second spacing 24 play a major supporting role. Other corresponding first spacers 15 and second spacers 24 are respectively offset by a distance of 2d in the upward, downward, left and right directions.

As shown in FIG. 12, if there is a downward misalignment, for example, a misalignment of 10 microns, the second first peripheral spacing and its corresponding second spacing 24 play a major supporting role. Other corresponding first spacers 15 and second spacers 24 are respectively offset by a distance of 2d in the upward, downward, left and right directions.

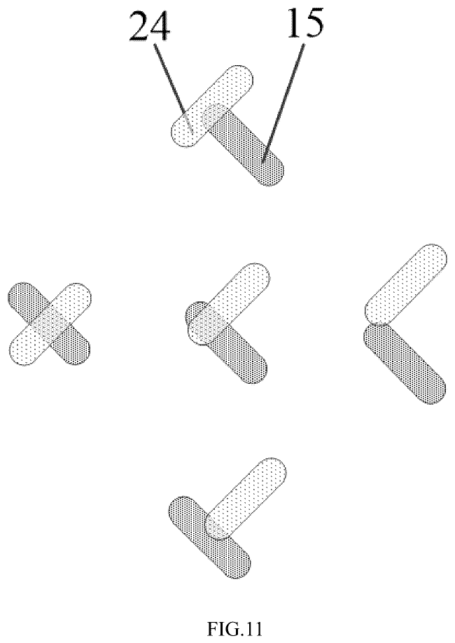

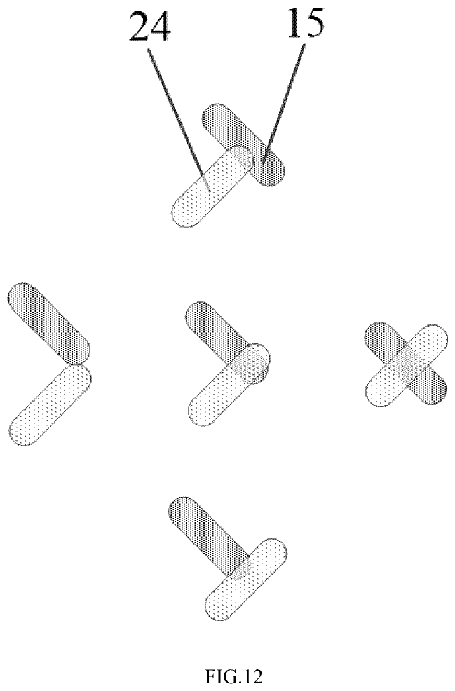

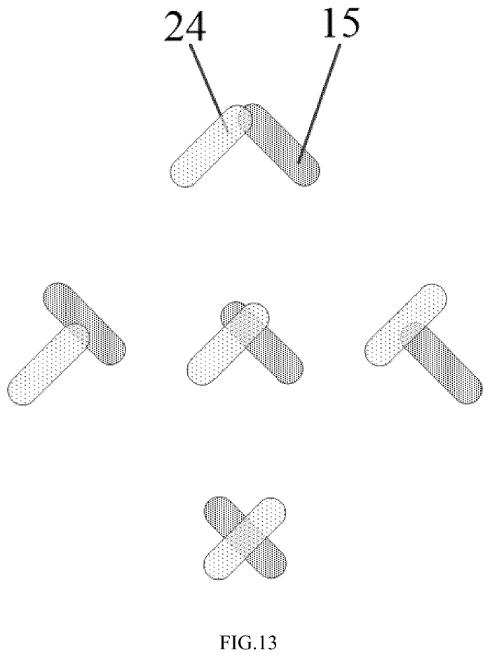

As shown in FIG. 13, if there is a misalignment to the left, for example, a misalignment of 10 microns, the fourth first peripheral spacing and its corresponding second spacing 24 play a major supporting role. The other corresponding first spacers 15 and second spacers 24 are respectively offset by a distance of 2d in the upward, downward, left and right directions.

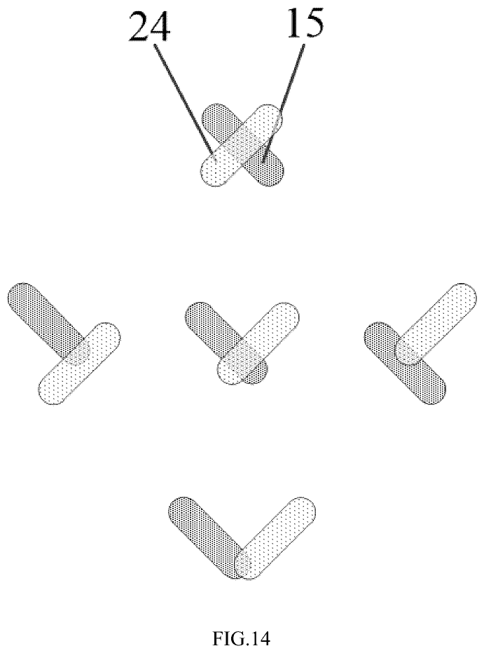

As shown in FIG. 14, if there is a misalignment to the right, for example, a misalignment of 10 microns, the third first peripheral spacing and its corresponding second spacing 24 play a major supporting role. The other corresponding first spacers 15 and second spacers 24 are respectively offset by a distance of 2d in the upward, downward, left and right directions.

The above arrangement ensures that, under the premise of ensuring that the size of the spacing is small enough, when the box is misaligned, at least part of the middle part of the first spacing 15 can contact the middle part of the corresponding second spacing 24, thereby achieving good support.

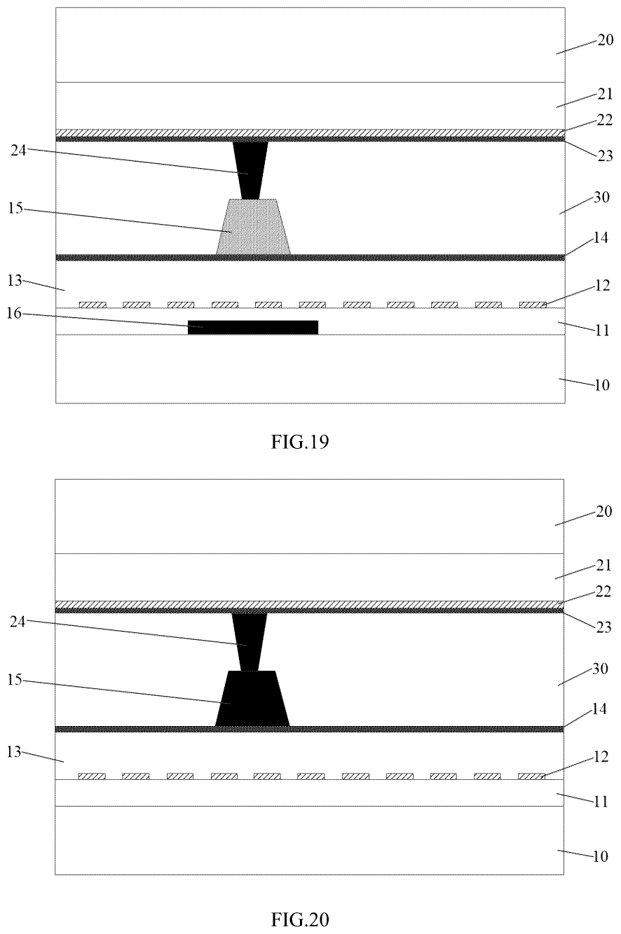

As shown in FIGS. 15 to 19, in some embodiments, the first substrate includes a first light shielding layer 16, at least a portion of the first light shielding layer 16 is located between the first spacing 15 and the first base substrate 10, and an orthographic projection of the first spacing 15 on the first base substrate 10 at least partially overlaps with an orthographic projection of the first light shielding layer on the first base substrate 10; and/or,

The second substrate includes a second shading layer 25, at least part of which is located between the second spacing 24 and the second base substrate 20, and the orthographic projection of the second spacing 24 on the second base substrate 20 at least partially overlaps with the orthographic projection of the second shading layer on the second base substrate 20.

Exemplarily, the orthographic projection of the first spacing 15 on the first base substrate 10 is located inside the orthographic projection of the first light shielding layer 16 on the first base substrate 10. The orthographic projection of the second spacing 24 on the second base substrate 20 is located inside the orthographic projection of the second light shielding layer 25 on the second base substrate 20.

Exemplarily, the first light shielding layer 16 and the second light shielding layer 25 can be made of light shielding materials separately, for example, black organic material, but not limited thereto.

Exemplarily, the first light shielding layer 16 and the second light shielding layer 25 can be formed in the same process as the existing film layer in the liquid crystal lens to simplify the manufacturing process.
the light leakage near the spacing, avoid the formation of light leakage crosstalk, and ensure the 3D display effect.

As shown in FIGS. 15 to 19, in some embodiments, the first substrate includes:
alignment layer 14 are sequentially stacked on the first base substrate 10 in a direction away from the first base substrate 10;

The first spacing 15 is located on a side of the first alignment layer 14 facing away from the first base substrate 10;
in FIG. 15, the first light shielding layer 16 and the gate metal layer are provided in the same layer and made of the same material; or,

The first light shielding layer 16 is located on the surface of the gate metal layer facing away from the first base substrate 10; or,

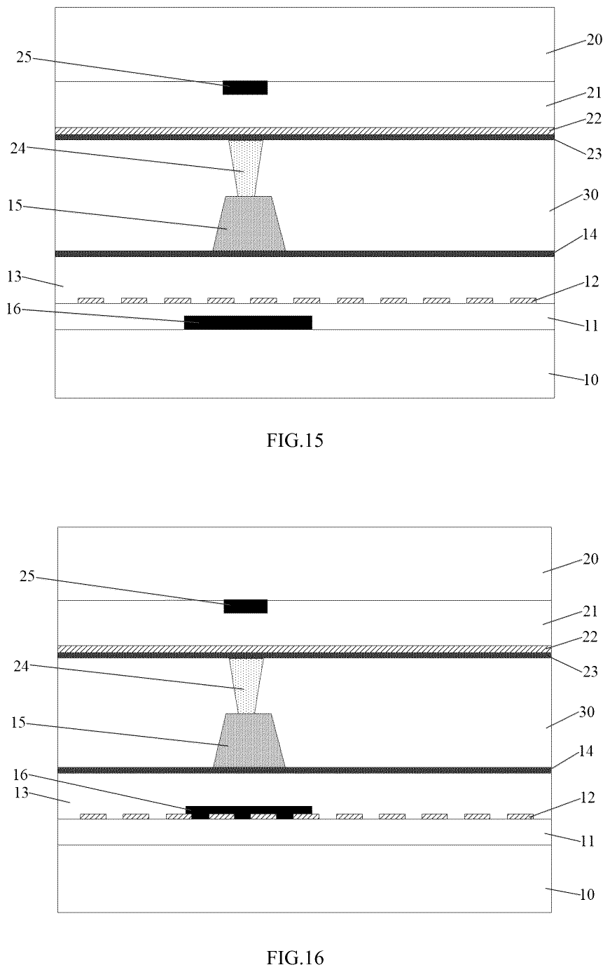

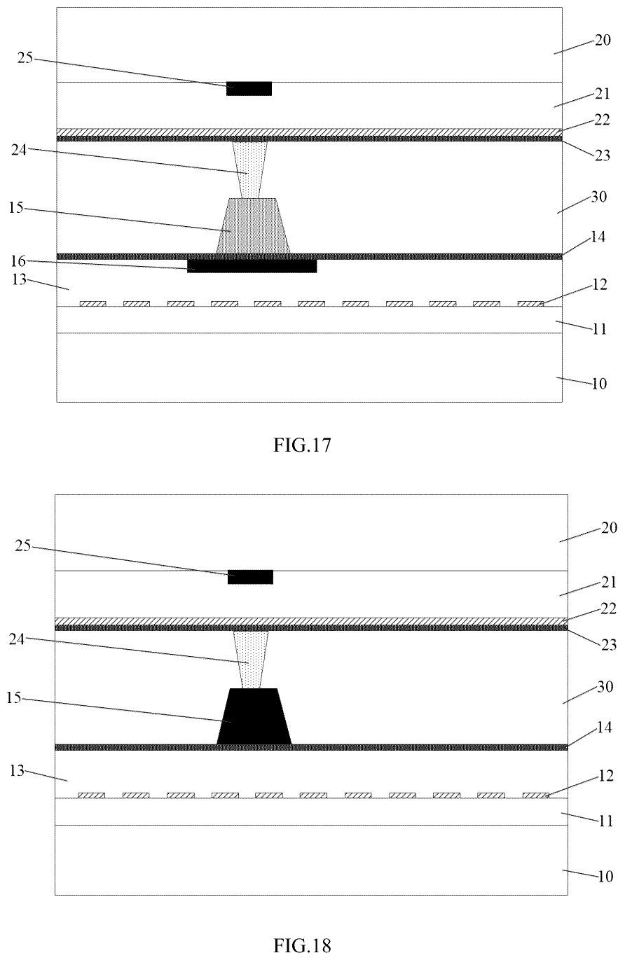

The first light shielding layer 16 is located on the surface of the first insulating layer 11 facing away from the first base substrate 10; or,
in FIG. 16, the first light shielding layer 16 is located on the surface of the first electrode layer 12 facing away from the first base substrate 10; or,
in FIG. 17, the first light shielding layer 16 is located on the surface of the shielding layer 13 facing away from the first base substrate 10.

Exemplarily, the gate metal layer is used to form a signal line included in the first substrate. The first light shielding layer 16 and the gate metal layer are provided in the same layer and with the same material, which can effectively simplify the manufacturing process.

Exemplarily, the first insulating layer 11 is used to protect the gate metal layer, and the material of the first insulating layer 11 may be the same as that of the passivation layer. For example, the first insulating layer 11 may be made of an inorganic insulating layer, but is not limited thereto.

As shown in FIGS. 15 to 19, in some embodiments, the second substrate includes:
alignment layer 23 are sequentially stacked on the second base substrate 20 in a direction away from the second base substrate 20; the second light shielding layer 25 is located between the second base substrate 20 and the second planar layer 21.

Exemplarily, the second spacing 24 is located on a side of the second alignment layer 23 facing away from the second base substrate 20.

The second light shielding layer 25 is arranged between the second base substrate 20 and the second flat layer 21, which can better ensure the flatness of the surface of the second electrode layer 22, and prevent the second light shielding layer 25 from causing a step difference in the film layer formed subsequently. At the same time, the second flat layer 21 can play a role in flattening and protecting the second light shielding layer 25, and prevent the particles in the second light shielding layer 25 from being resolved into the liquid crystal layer 30, causing local liquid crystal failure.

As shown in FIGS. 18 to 20, in some embodiments, the first spacing 15 and/or the second spacing 24 include light-shielding spacers.

Exemplarily, the first spacing 15 and/or the second spacing 24 are made of black material to form a light-shielding spacing having a light-shielding function, but the invention is not limited thereto.

It should be noted that, in the case where the first spacing 15 and/or the second spacing 24 include light-shielding spacers, the first light-shielding layer 16 and the second light-shielding layer 25 may be provided or not according to actual needs.

The above arrangement can achieve shielding of light leakage near the spacing to avoid light leakage crosstalk, while effectively simplifying the manufacturing process of the liquid crystal lens and reducing the thickness of the liquid crystal lens.

As shown in FIGS. 1 and 21 to 26, in some embodiments, at least one of the first electrode layer 12 and the second electrode layer 22 includes at least one sub-electrode layer, and the sub-electrode layer includes a plurality of electrode patterns A arranged in sequence, with gaps between adjacent electrode patterns A.

Exemplarily, the sub-electrode layer is formed as a slit structure.

Exemplarily, as shown in FIG. 1, the first electrode layer 12 includes a layer of the sub-electrode layer, the second electrode layer 22 does not include the sub-electrode layer, and the second electrode layer 22 is formed as an integral structure of the entire surface. In this case, the first electrode layer 12 is a pixel electrode, and the second electrode layer 22 is a common electrode.

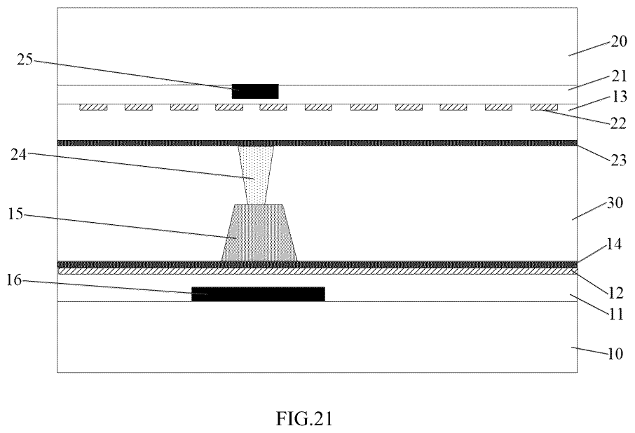

Exemplarily, as shown in FIG. 21, the second electrode layer 22 includes a layer of the sub-electrode layer, the first electrode layer 12 does not include the sub-electrode layer, and the first electrode layer 12 is formed as an integral structure of the entire surface. In this case, the second electrode layer 22 is a pixel electrode, and the first electrode layer 12 is a common electrode.

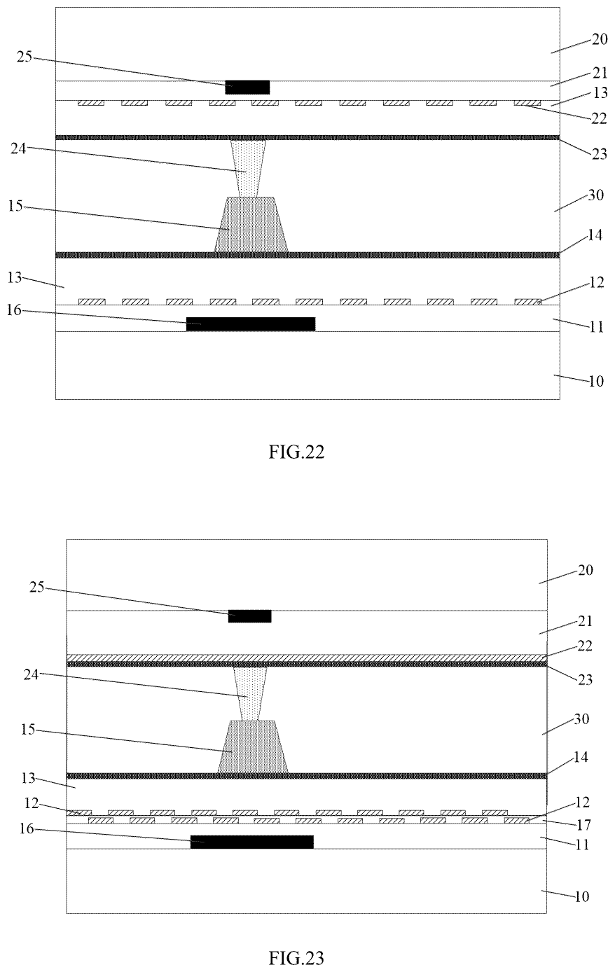

Exemplarily, as shown in FIG. 22, the first electrode layer 12 includes one layer of the sub-electrode layer, and the second electrode layer 22 includes one layer of the sub-electrode layer. In this case, one of the first electrode layer 12 and the second electrode layer 22 is a pixel electrode, and the other is a common electrode. It is worth noting that in this case, since the common electrode is also formed as a structure including a plurality of electrode patterns, a shielding layer 13 may also be formed between the common electrode and the liquid crystal layer 30.

Exemplarily, as shown in FIG. 23, the first electrode layer 12 includes two layers of the sub-electrode layers, the second electrode layer 22 does not include the sub-electrode layer, and the second electrode layer 22 is formed as an integrated structure of the entire surface. In this case, the first electrode layer 12 is a pixel electrode, and the second electrode layer 22 is a common electrode. The first electrode layer 12 includes two layers of the sub-electrode layers, and an insulating layer 17 is provided between them.

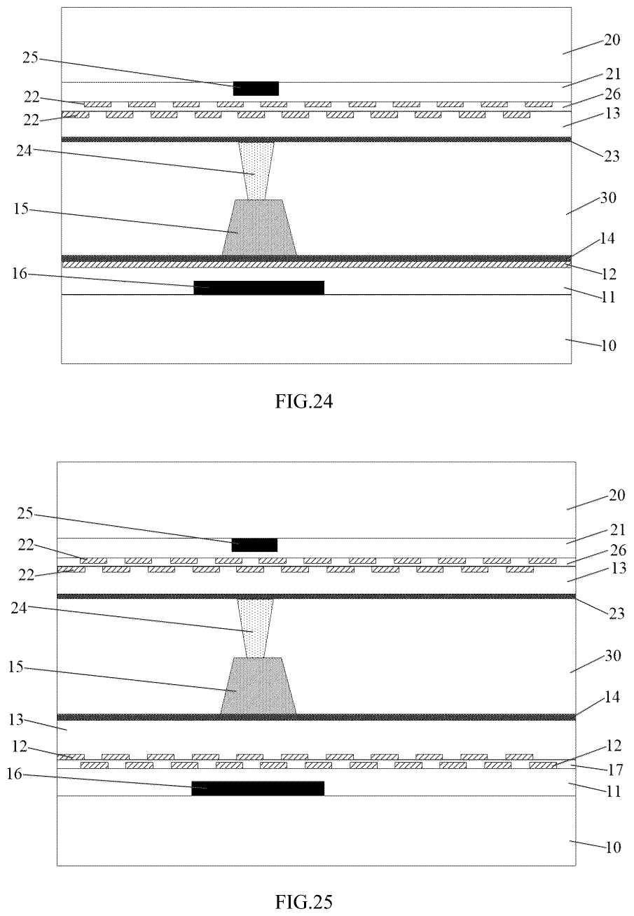

Exemplarily, as shown in FIG. 24, the second electrode layer 22 includes two layers of the sub-electrode layers, the first electrode layer 12 does not include the sub-electrode layer, and the first electrode layer 12 is formed as an integrated structure of the entire surface. In this case, the second electrode layer 22 is a pixel electrode, and the first electrode layer 12 is a common electrode. FIG. 24 also illustrates an insulating layer 26, which can have a flat function according to actual needs.

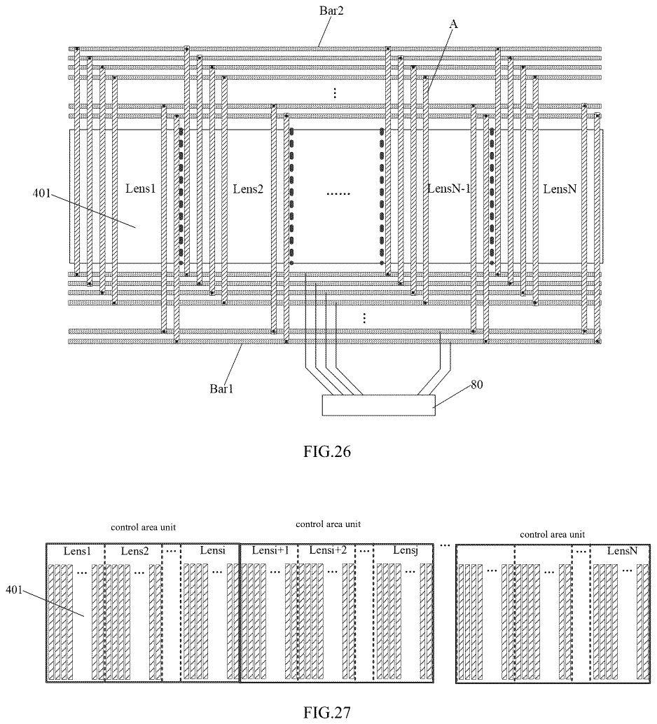

Exemplarily, as shown in FIG. 25, the first electrode layer 12 includes two sub-electrode layers, and the second electrode layer 22 includes two sub-electrode layers. In this case, one of the first electrode layer 12 and the second electrode layer 22 is a pixel electrode, and the other is a common electrode.
in FIG. 26, illustratively, the width of the electrode pattern A is about 2 μm.

The above-mentioned setting of at least one of the first electrode layer 12 and the second electrode layer 22 includes at least one sub-electrode layer, and the sub-electrode layer includes a plurality of electrode patterns A arranged in sequence, which can make the Pitch of the electrode pattern A included in the first electrode layer 12 and/or the second electrode layer 22 smaller, and can improve the density of the electric field, thereby better improving the fineness of the liquid crystal lens control.

FIG. 25, in some embodiments, when at least one of the first electrode layer 12 and the second electrode layer 22 includes at least two sub-electrode layers, there is an insulating layer between adjacent sub-electrode layers, and among the adjacent sub-electrode layers, the orthographic projection of the electrode pattern A in one sub-electrode layer on the first base substrate 10 at least partially overlaps with the orthographic projection of the gap between adjacent electrode patterns A in another sub-electrode layer on the first base substrate 10.

Exemplarily, the insulating layer may have only an insulating function, or the insulating layer may have both insulating and planarizing functions.

The above configuration enables the electrode patterns A located in different layers to be arranged in a staggered manner, thereby better improving the precision of liquid crystal lens control.

As shown in FIG. 26, in some embodiments, the liquid crystal lens includes a plurality of lens control areas 401, each lens control area 401 corresponding to controlling a lens (such as lenses Lens1, Lens2, LensN−1, LensN); the liquid crystal lens also includes a plurality of first shorting bars Bar1 and a plurality of second shorting bars Bar2, the plurality of first shorting bars Bar1 are located on a first side of the electrode pattern A, the plurality of second shorting bars Bar2 are located on a second side of the electrode pattern A, and the first side and the second side are opposite to each other along the extension direction of the electrode pattern A;

The first shorting bar Bar1 is coupled to the first end of the corresponding electrode pattern A in each lens control area 401, and the second shorting bar Bar2 is coupled to the second end of the corresponding electrode pattern A in each lens control area 401.

Exemplarily, each lens control area 401 may include at least one layer of electrode pattern A.

The first shorting bar Bar1 and the shorting bar Bar2 are coupled to the driving structure 80 in the liquid crystal lens to receive the driving signal provided by the driving structure 80. Exemplarily, the driving structure 80 includes a chip-on-film, but is not limited thereto.

In the above embodiment, the first shorting bar Bar1 and the second shorting bar Bar2 are respectively arranged at the two ends of the electrode pattern A, and the first shorting bar Bar1 and the second shorting bar Bar2 are respectively coupled to the driving structure 80, so that when a breakpoint appears in the electrode pattern A, the first shorting bar Bar1 and the second shorting bar Bar2 can still provide driving signals for the two disconnected parts respectively, ensuring that the electrode pattern A with a breakpoint can still receive the driving signal normally, thereby effectively improving the yield of the liquid crystal lens.

FIG. 27, in some embodiments, the plurality of lens control areas 401 are divided into a plurality of control area units, each of which includes at least one lens control area 401;

The first shorting bar Bar1 includes a plurality of first sub-shorting bars that are independent of each other, and the first sub-shorting bars are respectively coupled to the first ends of the corresponding electrode patterns A in each lens control area 401 in the corresponding control area unit;

The second shorting bar Bar2 includes a plurality of second sub-shorting bars that are independent of each other, and the second sub-shorting bars are respectively coupled to the second ends of the corresponding electrode patterns A in each lens control area 401 in the corresponding control area unit.

Exemplarily, the control area unit includes at least two adjacent lens control areas 401.

Illustratively, the number of lens control areas 401 included in each control area unit may be the same or different.

Exemplarily, the first sub-shorting bars correspond to the control area units one by one, and the second sub-shorting bars correspond to the control area units one by one.

It is worth noting that when the human eye is at a fixed position viewing the screen, in order to provide the viewer with the best 3D visual effect, the lenses at different positions on the screen should be set to different morphologies. If each electrode pattern A is controlled independently, the amount of data is huge and the driving structure 80 is difficult to support.

In the solution provided in the above embodiment, it is divided into multiple control area units, and the electrode pattern A in each control area unit can be independently controlled by the corresponding first sub-short-circuit bar and the second sub-short-circuit bar. Multiple electrode patterns A coupled to the same first sub-short-circuit bar and the second sub-short-circuit bar in each control area unit receive the same driving signal. This setting method can achieve independent regulation of multiple control area units within the driving capability of the existing driving structure 80, thereby optimizing the 3D visual effect.

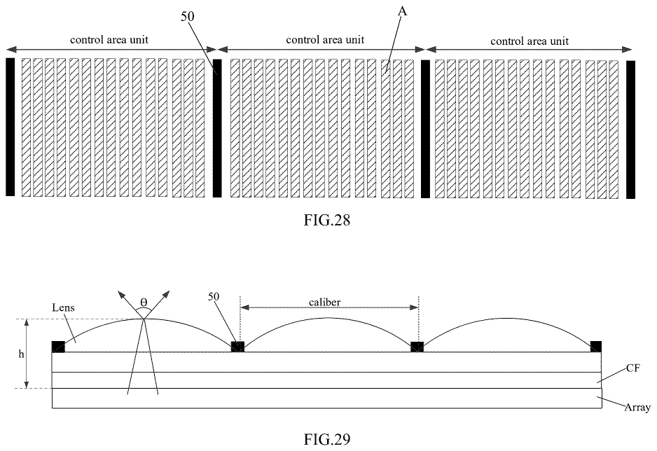

As shown in FIGS. 28 and 29, in some embodiments, the liquid crystal lens further includes a shading unit 50, and the orthographic projection of the shading unit 50 on the first base substrate 10 at least partially overlaps with the orthographic projection of the boundary between adjacent control area units on the first base substrate 10.

Exemplarily, the shading unit 50 may be disposed on the first substrate and/or the second substrate.

Exemplarily, the width of the shading unit 50 ranges from 0 to 70 μm.

Exemplarily, the shading unit 50 may be provided in the same layer and with the same material as the first spacing 15 and the second spacing 24, or may be manufactured separately.

It should be noted that there is a voltage mutation at the junction between adjacent control area units, and the liquid crystal is disordered, which causes crosstalk at the junction and affects the light field effect.

The design of adding a shading unit 50 at the junction between adjacent control area units can block light from the disturbance zone, thereby preventing the formation of crosstalk.

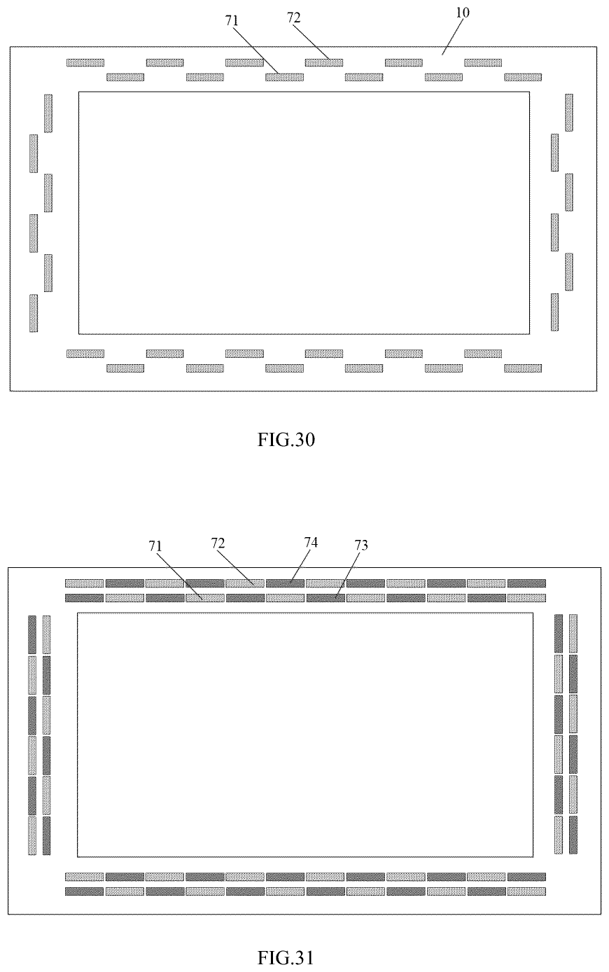

As shown in FIG. 30, in some embodiments, the first substrate further includes a plurality of first blocking patterns 71 and a plurality of second blocking patterns 72; the orthographic projections of the plurality of first blocking patterns 71 on the first base substrate 10 surround the orthographic projections of the liquid crystal layer 30 on the first base substrate 10; the orthographic projections of the plurality of second blocking patterns 72 on the first base substrate 10 surround the orthographic projections of the liquid crystal layer 30 on the first base substrate 10;

The second barrier pattern 72 is located on a side of the first barrier pattern 71 facing away from the liquid crystal layer 30, and a gap between adjacent first barrier patterns 71 is located between the liquid crystal layer 30 and the second barrier pattern 72.

Exemplarily, there are gaps between adjacent first barrier patterns 71 and there are gaps between adjacent second barrier patterns 72.

Exemplarily, the orthographic projections of the plurality of second barrier patterns 72 on the first base substrate 10 surround the orthographic projections of the plurality of second barrier patterns 72 on the first base substrate 10.

Exemplarily, the first barrier pattern 71 and the second barrier pattern 72 have the same height as the first spacing 15.

Exemplarily, the first substrate and the second substrate are bonded together by a sealant. The first barrier pattern 71 and the second barrier pattern 72 are located in the area where the sealant is located.

It is worth noting that in order to achieve a greater depth of field and a better 3D effect, the design value of the thickness of the liquid crystal box in the liquid crystal lens will be relatively thick, generally reaching about 30 μm, or even thicker, and the amount of liquid crystal in the liquid crystal layer 30 is more than ten times that of conventional products. In this way, during the sample production process, the liquid crystal dripping time is also more than ten times that of conventional products. If the liquid crystal dripping amount is large and the dripping time is too long, the risk of liquid crystal diffusing to the frame sealant coating area before the box is aligned will be greatly increased. Moreover, at the moment of vacuuming the box, under the action of negative pressure, the liquid crystal may instantly break through the uncured frame sealant, causing leakage.

The above-mentioned first substrate is configured to include a first barrier pattern 71 and a second barrier pattern 72 with a breakpoint design, and the first barrier pattern 71 and the second barrier pattern 72 are arranged alternately, so that the first barrier pattern 71 and the second barrier pattern 72 can play a buffering role in the liquid crystal diffusion process, reduce the diffusion speed, and reduce the impact on the sealing glue, while ensuring that the liquid crystal can be fully diffused to avoid the formation of a vacuum bubble, thereby effectively improving the yield.

As shown in FIG. 31, in some embodiments, the second substrate further includes a plurality of third blocking patterns 73 and a plurality of fourth blocking patterns 74; the orthographic projections of the third blocking patterns 73 on the first base substrate 10 are alternately arranged with the orthographic projections of the first blocking patterns 71 on the first base substrate 10, and the orthographic projections of the fourth blocking patterns 74 on the first base substrate 10 are alternately arranged with the orthographic projections of the third blocking patterns 73 on the first base substrate 10.

Exemplarily, there are gaps between adjacent third barrier patterns 73. There are gaps between adjacent fourth barrier patterns 74.

Exemplarily, the orthographic projections of the plurality of fourth barrier patterns 74 on the first base substrate 10 surround the orthographic projections of the plurality of third barrier patterns 73 on the first base substrate 10.

Exemplarily, the third barrier pattern 73 and the fourth barrier pattern 74 have the same height as the second spacing 24.

Exemplarily, the first substrate and the second substrate are bonded together by a sealant. The third barrier pattern 73 and the fourth barrier pattern 74 are located in the area where the sealant is located.

As shown in FIG. 31, the first blocking pattern and the second blocking pattern in the first substrate are asymmetrically designed along the center line of the liquid crystal lens. The third blocking pattern and the fourth blocking pattern in the second substrate are asymmetrically designed along the center line of the liquid crystal lens.

The above-mentioned setting method allows the production of the third retaining wall pattern and the fourth retaining wall pattern using a mask plate for the production of the first retaining wall pattern and the second retaining wall pattern, and after the first substrate and the second substrate are boxed, the retaining wall patterns located on different substrates do not overlap, thereby avoiding peripheral Gap Mura caused by excessive support in the peripheral area.

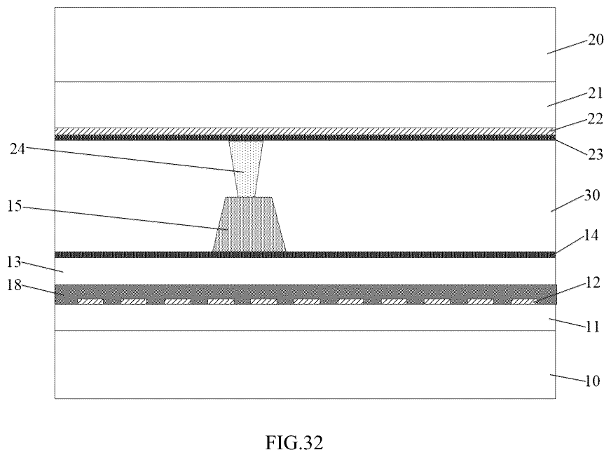

As shown in FIGS. 1 and 32, in some embodiments, the light compensation layer 18 is located on the side of the sub-electrode layer facing the liquid crystal layer 30, the thickness of the light compensation layer 18 in the direction perpendicular to the first substrate is greater than the thickness of the sub-electrode layer, and the light compensation layer 18 is reused as a shielding layer 13.

The above configuration is beneficial to simplifying the process flow of the liquid crystal lens and reducing the thickness of the liquid crystal lens.

The embodiment of the present disclosure further provides a display device, comprising the liquid crystal lens provided by the above embodiment.

Exemplarily, the display device further includes a display panel, and the liquid crystal lens is located on a light emitting side of the display panel.

It should be noted that the display device can be any product or component with a display function, such as a television, a monitor, a digital photo frame, a mobile phone, a tablet computer, etc., wherein the display device also includes a flexible circuit board, a printed circuit board and a backplane, etc.
the above embodiment, by setting the thickness of the first base substrate to be smaller than the thickness of the second base substrate, when the liquid crystal lens is combined with a display panel to form a display product, the first base substrate can be set to face the display panel, thereby shortening the distance between the liquid crystal layer and the display panel, that is, reducing the height of the liquid crystal lens on the display panel, so that the display product can achieve a larger main lobe viewing angle when using liquid crystal lens technology.

In the solution provided in the above embodiment, a light compensation layer is provided to fill between adjacent electrode patterns in the sub-electrode layer. Since the refractive index of the light compensation layer is substantially the same as that of the sub-electrode layer, diffraction crosstalk between the electrode patterns in the sub-electrode layer is effectively avoided, thereby optimizing the 3D display effect.

In the solution provided by the embodiment of the present disclosure also has the above-mentioned beneficial effects when including the above-mentioned liquid crystal lens, which will not be described in detail here.

It should be noted that the signal line extends along the X direction means that the signal line includes a main part and a secondary part connected to the main part, the main part is a line, a line segment or a strip-shaped body, the main part extends along the X direction, and the length of the main part extending along the X direction is greater than the length of the secondary part extending along other directions.

It should be noted that the “same layer” in the embodiment of the present disclosure may refer to a film layer on the same structural layer. Or, for example, a film layer on the same layer may be a film layer for forming a specific pattern formed by the same film forming process, and then the film layer is patterned by the same mask through a single composition process to form a layer structure. Depending on the specific pattern, a single composition process may include multiple exposure, development or etching processes, and the specific pattern in the formed layer structure may be continuous or discontinuous. These specific patterns may also be at different heights or have different thicknesses.

In the various method embodiments of the present disclosure, the serial numbers of the steps cannot be used to limit the sequence of the steps. For ordinary technicians in this field, without paying any creative work, changes to the sequence of the steps are also within the protection scope of the present disclosure.

It should be noted that each embodiment in this specification is described in a progressive manner, and the same or similar parts between the embodiments can be referred to each other, and each embodiment focuses on the differences from other embodiments. In particular, for the method embodiment, since it is basically similar to the product embodiment, the description is relatively simple, and the relevant parts can be referred to the partial description of the product embodiment.

Unless otherwise defined, the technical terms or scientific terms used in the present disclosure should be understood by people with ordinary skills in the field to which the present disclosure belongs. The “first”, “second” and similar words used in the present disclosure do not indicate any order, quantity or importance, but are only used to distinguish different components. “Include” or “comprise” and similar words mean that the elements or objects appearing before the word cover the elements or objects listed after the word and their equivalents, without excluding other elements or objects. “Connect”, “couple” or “connected” and similar words are not limited to physical or mechanical connections, but can include electrical connections, whether direct or indirect. “Up”, “down”, “left”, “right” and the like are only used to indicate relative positional relationships. When the absolute position of the described object changes, the relative positional relationship may also change accordingly.

It will be understood that when an element such as a layer, film, region, or substrate is referred to as being “on” or “under” another element, it can be “directly on” or “under” the other element or intervening elements may be present.

In the description of the above embodiments, specific features, structures, materials or characteristics may be combined in a suitable manner in any one or more embodiments or examples.

The above is only a specific embodiment of the present disclosure, but the protection scope of the present disclosure is not limited thereto. Any person skilled in the art who is familiar with the technical field can easily think of changes or substitutions within the technical scope disclosed in the present disclosure, which should be included in the protection scope of the present disclosure. Therefore, the protection scope of the present disclosure should be based on the protection scope of the claims.

1. A liquid crystal lens, comprising: a first substrate and a second substrate arranged opposite to each other, and a liquid crystal layer located between the first substrate and the second substrate; wherein
the first substrate comprises a first base substrate and a first electrode layer disposed on the first base substrate, wherein the first electrode layer is located between the first base substrate and the liquid crystal layer;
the second substrate comprises a second base substrate and a second electrode layer disposed on the second base substrate, wherein the second electrode layer is located between the second base substrate and the liquid crystal layer;
at least one of the first electrode layer and the second electrode layer comprises at least one sub-electrode layer, and the sub-electrode layer comprises a plurality of electrode patterns arranged in sequence, with gaps between adjacent electrode patterns;
the liquid crystal lens further comprises at least one light compensation layer, at least part of which is filled between adjacent electrode patterns in the sub-electrode layer, and the refractive index of the light compensation layer is substantially the same as that of the sub-electrode layer.

2. The liquid crystal lens according to claim 1, wherein a thickness b of the first substrate satisfies: 0.1 mm≤b≤0.7 mm.

3. The liquid crystal lens according to claim 1, wherein the first substrate further comprises a plurality of first spacers, the second substrate further comprises a plurality of second spacers, and the orthographic projections of the first spacers on the first substrate at least partially overlap with the orthographic projections of the corresponding second spacers on the first substrate;
the orthographic projection of the first spacing on the base substrate and/or the orthographic projection of the second spacing on the base substrate has a first side and a second side, and the length L2 of the second side satisfies: L2=L1+2*a; L1 is the length of the first side, and a is the process deviation for manufacturing the spacing.

4. The liquid crystal lens according to claim 1, wherein the first substrate further comprises a plurality of first spacers, the second substrate further comprises a plurality of second spacers, and the orthographic projections of the first spacers on the first substrate at least partially overlap with the orthographic projections of the corresponding second spacers on the first substrate;
an extending direction of an orthographic projection of the first spacing on the first base substrate intersects with an extending direction of an orthographic projection of the second spacing on the first base substrate.

5. The liquid crystal lens according to claim 4, wherein
the plurality of first spacers are divided into a plurality of first spacing groups, wherein the first spacing group comprises a first central spacing and a plurality of first peripheral spacers located around the first central spacing;
the plurality of second spacers are divided into a plurality of second spacing groups, wherein the second spacing groups comprise a second central spacing and a plurality of second peripheral spacers located around the second central spacing;
in corresponding first spacing group and second spacing group: the middle part of the orthographic projection of at least one of the first central spacing and the plurality of first peripheral spacers on the first base substrate at least partially overlaps with the middle part of the orthographic projection of the second central spacing and at least one of the plurality of second peripheral spacers on the first base substrate.

6. The liquid crystal lens according to claim 5, wherein the orthographic projection of the first central spacing on the base substrate forms a central overlapping area with the orthographic projection of the second central spacing on the base substrate; the orthographic projection of the first peripheral spacing on the base substrate forms a peripheral overlapping area with the orthographic projection of the corresponding second peripheral spacing on the base substrate;
the middle part or end of the first central spacing is located in the central overlapping area; the middle part or end of the second central spacing is located in the central overlapping area; the middle part or end of the first peripheral spacing is located in the peripheral overlapping area; the middle part or end of the second peripheral spacing is located in the peripheral overlapping area.

7. The liquid crystal lens according to claim 6, wherein the first spacing group comprises one first central spacing and four first peripheral spacers, the first central spacing is located between the first first peripheral spacing and the second first peripheral spacing, the first first peripheral spacing and the second first peripheral spacing are opposite to each other along a first direction; the first central spacing is located between the third first peripheral spacing and the fourth first peripheral spacing, the third first peripheral spacing and the fourth first peripheral spacing are opposite to each other along a second direction, and the second direction intersects with the first direction;
along the second direction, the first first peripheral spacing, the first center spacing and the second first peripheral spacing are staggered by a distance d in sequence; along the first direction, the third first peripheral spacing, the first center spacing and the fourth first peripheral spacing are staggered by a distance d in sequence.

8. The liquid crystal lens according to claim 7, wherein the orthographic projection of at least one of the first central spacing, the third first peripheral spacing and the fourth first peripheral spacing on the first substrate is mirror-symmetrical to the orthographic projection of the corresponding second spacing on the first substrate;
an orthographic projection of a first first peripheral spacing on the first substrate is mirror-symmetrical to an orthographic projection of a second first peripheral spacing corresponding to the first peripheral spacing on the first substrate;
the second first peripheral spacing on the first base substrate is mirror-symmetrical to the orthographic projection of the second spacing corresponding to the first first peripheral spacing on the first base substrate.

9. The liquid crystal lens according to claim 4, wherein the first substrate comprises a first light-shielding layer, at least a portion of which is located between the first spacing and the first base substrate; and/or the second substrate comprises a second light-shielding layer, at least a portion of which is located between the second spacing and the second base substrate.

10. The liquid crystal lens according to claim 9, wherein the first substrate comprises:
alignment layer are sequentially stacked on the first substrate in a direction away from the first substrate;
the first spacing is located on a side of the first alignment layer facing away from the first substrate;
the first light shielding layer and the gate metal layer are provided in the same layer and made of the same material; or,
the first light shielding layer is located on the surface of the gate metal layer facing away from the first substrate; or,
the first light shielding layer is located on the surface of the first insulating layer facing away from the first substrate; or,
the first light shielding layer is located on the surface of the first electrode layer facing away from the first substrate; or,
the first light shielding layer is located on a surface of the shielding layer facing away from the first substrate.

11. The liquid crystal lens according to claim 9, wherein the second substrate comprises:
in the direction away from the second substrate, a second planar layer, a second electrode layer, and a second alignment layer sequentially stacked on the second substrate; the second shading layer is located between the second substrate and the second planar layer.

12. The liquid crystal lens according to claim 4, wherein the first spacing and/or the second spacing comprises a light shielding spacing.

13. The liquid crystal lens according to claim 1, wherein one of the first electrode layer and the second electrode layer serves as a pixel electrode, and the other serves as a common electrode, and a shielding layer is provided between the pixel electrode and the liquid crystal layer.

14. The liquid crystal lens according to claim 1, wherein, when at least one of the first electrode layer and the second electrode layer comprises at least two sub-electrode layers, an insulating layer is provided between adjacent sub-electrode layers, and among the adjacent sub-electrode layers, an orthographic projection of an electrode pattern in one sub-electrode layer on the first substrate at least partially overlaps with an orthographic projection of a gap between adjacent electrode patterns in another sub-electrode layer on the first substrate.

15. The liquid crystal lens according to claim 1, wherein the liquid crystal lens comprises a plurality of lens control areas, each lens control area correspondingly controlling one lens;
the liquid crystal lens further comprises a plurality of first shorting bars and a plurality of second shorting bars, wherein the plurality of first shorting bars are located on a first side of the electrode pattern, and the plurality of second shorting bars are located on a second side of the electrode pattern, and the first side and the second side are opposite to each other along an extension direction of the electrode pattern;
the first shorting bars are coupled to the first end of the corresponding electrode pattern in each lens control area respectively, and the second shorting rod is coupled to the second end of the corresponding electrode pattern in each lens control area respectively.

16. The liquid crystal lens according to claim 15, wherein the plurality of lens control areas are divided into a plurality of control area units, each control area unit comprising at least one lens control area;
the first shorting rod comprises a plurality of first sub-shorting rods which are independent of each other, and the first sub-shorting rods are respectively coupled to the first ends of the corresponding electrode patterns in each lens control area in the corresponding control area unit;
the second shorting rod comprises a plurality of second sub-shorting rods that are independent of each other, and the second sub-shorting rods are respectively coupled to the second ends of the corresponding electrode patterns in each lens control area in the corresponding control area unit.

17. The liquid crystal lens according to claim 16, wherein the liquid crystal lens further comprises a shading unit, and an orthographic projection of the shading unit on the first substrate at least partially overlaps with an orthographic projection of a boundary between adjacent control area units on the first substrate.

18. The liquid crystal lens according to claim 11, wherein the first substrate further comprises a plurality of first blocking patterns and a plurality of second blocking patterns; the orthographic projections of the plurality of first blocking patterns on the first substrate surround the orthographic projection of the liquid crystal layer on the first substrate; the orthographic projections of the plurality of second blocking patterns on the first substrate surround the orthographic projection of the liquid crystal layer on the first substrate;
the second barrier pattern is located at a side of the first barrier pattern facing away from the liquid crystal layer, and a gap between adjacent first barrier patterns is located between the liquid crystal layer and the second barrier pattern;
wherein the second substrate further comprises a plurality of third blocking patterns and a plurality of fourth blocking patterns; the orthographic projections of the third blocking patterns on the first substrate are arranged alternately with the orthographic projections of the first blocking patterns on the first substrate, and the orthographic projections of the fourth blocking patterns on the first substrate are arranged alternately with the orthographic projections of the third blocking patterns on the first substrate.

19. (canceled)

20. The liquid crystal lens according to claim 1, wherein the light compensation layer is located on a side of the sub-electrode layer facing the liquid crystal layer, a thickness of the light compensation layer in a direction perpendicular to the first substrate is greater than a thickness of the sub-electrode layer, and the light compensation layer is multiplexed as a shielding layer.

21. A display device comprising the liquid crystal lens according to claim 1.
